(19) United States
(12) Patent Application Publication
(10) Pub. No.: US 2012/0056404 A1
(43) Pub. Date: Mar. 8, 2012

(54) MANUAL WHEELCHAIR LIFT AND METHODS OF USING SAME

(76) Inventor: Bradley J. Rousseau, White Bear Lake, MN (US)

(21) Appl. No.: 13/183,219

(22) Filed: Jul. 14, 2011

Related U.S. Application Data
(63) Continuation-in-part of application No. 12/629,448, filed on Dec. 2, 2009.

(51) Int. Cl. A61G 5/10

(52) U.S. Cl. 280/304.1

(57) ABSTRACT

A device that detachably mounts to the front side of a wheelchair frame, or similar vehicle, to manually lift or otherwise manipulate an occupied wheelchair p and/or down stairs. The manual wheelchair lift attachment comprises a wheelchair attachment portion and a handhold member for lifting that is connected by connecting arms. The wheelchair lift attachment apparatus may be adjustable to be configured with different sized wheelchairs. The invention also relates to a wheelchair having a permanent wheelchair frame that operably accepts a lifting mechanism apparatus. The invention also relates to a method of using the foregoing attachment and permanent configuration to transport an occupied wheelchair up and/or down stairs or otherwise maneuver the occupied wheelchair about other similar obstacles.

### RELATED APPLICATION

This application is a continuation-in-part of application Ser. No. 12/629,448 filed Dec. 2, 2009, which is hereby fully incorporated herein by reference.

### FIELD OF THE INVENTION

The invention relates generally to wheelchairs. More particularly, this invention relates to a device that attaches to the front side of a wheelchair frame, or similar vehicles, to manually lift or otherwise manipulate such wheelchairs and its occupant up and/or down stairs. The manual wheelchair lift attachment device also functions as a brace to protect collapsible wheelchairs against unintended collapse. The manual wheelchair lift attachment device further functions as a footrest for its occupant. The invention also relates to a wheelchair having a permanent wheelchair frame that operably accepts a lifting mechanism. The invention also relates to a method of using the foregoing attachment or alternative permanent configuration to transport a wheelchair occupant up and/or down stairs.

### BACKGROUND OF THE INVENTION

Wheelchairs are ubiquitous and come in many different styles, models, and sizes. Wheelchair users are faced with many problems, but one of the most common problems wheelchair users face is overcoming obstacles that inhibit their ability to traverse their surroundings that are not relatively smooth and flat or otherwise wheelchair friendly, such as stairs that inhibit their ability to move between floors or levels of a building. The ability to overcome the problem associated with stairs has been addressed on multiple levels. For instance, laws and regulations have been passed by governments or agencies requiring buildings to be handicap accessible. Whether a result of such rules and regulations or the purpose of addressing this problem, many devices have been developed to help wheelchair users traverse flights of stairs or otherwise move between levels in a building (e.g., elevators, motorized wheelchair lifts, ramps, stair and step climbing wheelchairs, and the like). Despite all these efforts, there are numerous situations and locations where these efforts may not be practical or even possible.

For instance, acquiring many of the foregoing devices in order to traverse flights of stairs may not be financially practical for someone with a limited source of income or monetary means. Further, some individuals may be wheelchair-bound for a temporary basis before recovery and the cost associated with acquiring such devices may not make long-term financial sense. Other individuals may be wheelchair-bound as a result of deteriorating health and such devices may not be a practical solution. Still further, a wheelchair user's home may not be able to be equipped with an elevator or even a ramp. Many other buildings throughout the world, such as churches, office buildings or other institutions, may not be able to incorporate such devices due to space constraints, the layout of the building, monetary considerations, or other such reasons.

As a result, when a wheelchair user wants or otherwise needs to traverse a flight of stairs in buildings where such devices are not present, an attendant such as family, friends or even acquaintances may help the wheelchair user up the stairs and/or down the stairs by lifting or otherwise physically manipulating the wheelchair and its user with respect to the stairs. During this process, the people helping the wheelchair user are susceptible to getting injured by improper lifting techniques that may be employed as a result of the situation. The people helping the wheelchair user may also have their own health problems that may be affected by strenuous lifting or maneuvering of a wheelchair and its occupant. Also, due to the weight of the wheelchair and the occupant, the wheelchair occupant is susceptible of being dropped or otherwise injured should one of the people helping either get hurt or otherwise lose their grip and drop the wheelchair and its occupant.

Even when handicap accessible devices are present, the use of such devices may not be possible under the given situation. For instance, in the event of a fire or other emergency in hospitals, nursing homes, high-rise buildings, or other multi-leveled institutions that require those inside to evacuate, an elevator may not be accessible at all, or alternatively, filled to its capacity. As a result, the staircase may be the only remaining option for a wheelchair user to exit the building. In such situations, again, both the people helping the wheelchair user and the wheelchair user are susceptible to injury and even serious bodily harm. It may be appreciated from the foregoing that there are many problems associated with the need to lift or otherwise maneuver a wheelchair and its occupant up and/or down flights of stairs. The present invention provides a solution for these and other problems.

### SUMMARY OF THE INVENTION

It would be desirable to provide a wheelchair with permanent and/or attachment means which helps overcome the problems associated with lifting a wheelchair and its occupant up and/or down stairs. It would also be desirable to provide a wheelchair attachment that in the event of an emergency may be easily attached to a standard wheelchair to help facilitate moving the wheelchair and its occupant up or down a flight of stairs. It would also be desirable to provide a wheelchair attachment that may be easily attached and maintained on a standard wheelchair to help facilitate moving the wheelchair and its occupant that frequently must traverse a flight of stairs. It would also be desirable to provide a wheelchair attachment that may adjust to fit different sized wheelchairs. It would also be desirable to provide a wheelchair attachment that helps address the foregoing problems that is easy to use, robust, lightweight and cost-effective. It would also be desirable to provide a wheelchair with permanent structure that contains the entirety or a portion of such an attachment.

It is a present object of the present invention to provide a wheelchair lift apparatus that allows the front side of an occupied wheelchair to be easily lifted or otherwise maneuvered by an attendant, including attendants that are not trained or otherwise work in a healthcare environment.

It is another object of the present invention to provide a wheelchair lift apparatus that is easy to mount to the wheelchair, easy to use when detachably mounted, and safe.

It is another object of the present invention to provide a wheelchair lift apparatus that may be maintained on a standard wheelchair when not in use, while at the same time not being in the way of the user.

According to preferred embodiments of the invention, the invention is directed to a wheelchair lift apparatus that comprises a hand hold member connected to a wheelchair attachment portion by at least one connecting arm, and preferably two connecting arms. When the wheelchair lift apparatus is connected to the wheelchair, the attendant can lift up on the hand hold member to lift or other maneuver the front side of a wheelchair while another attendant uses the standard handles on the backside of the wheelchair. In a preferred embodiment, the wheelchair attachment portion detachably attaches to the two vertical frame members on the front side of the wheelchair by virtue of two plugs operably inserting into the hollow frame members. The two plugs are separated and supported by a lower horizontal member, or optionally vertical support members separated by the lower horizontal member. The wheelchair attachment portion also contains an upper horizontal member that presses against the vertical frame members of the wheelchair when the attendant lifts upwards on the hand hold member.

In a preferred embodiment, the wheelchair attachment portion contains a backing bar member that provides compression pressure with the upper horizontal bar to the two front vertical frame members. The backing bar member provides support to the wheelchair attachment portion in both the horizontal direction and the vertical direction by maintaining the plug members within the apertures of the two front vertical frame members.

In a preferred embodiment, at least one of the two plug members are adjustable with respect to the lower horizontal member to accommodate different sized wheelchairs, and alternatively both plug members are adjustable. The upper horizontal member may also be adjusted in the vertical direction with respect to the support members to provide additional support and safety measures.

In a preferred embodiment, the connecting arm members are adjustable between a retracted position and an extended position such that the hand hold members may abut the wheelchair attachment portion in the retracted position. In this embodiment, the hand hold members and connecting arm members may be maintained on the wheelchair in a position that is out of the way for the occupant's normal use, while conveniently being available for an attendant when the occupied wheelchair needs to be lifted up and/or down a flight of stairs or otherwise maneuvered.

In a preferred embodiment, the upper horizontal member contains frame engaging members that prevent the wheelchair from collapsing when the wheelchair lift apparatus is used. Each of the frame engaging members contact the two vertical frame members and may take on different configurations, such as hooking members, concave engaging members that engage a front side of the vertical frame member, bus members that engage the front side and an interior side of the vertical frame member, or a combination thereof.

In a preferred embodiment, the connecting arm members connect to the lower horizontal member such that the angle between the connecting arm members and the floor when the wheelchair lift apparatus is connected to the wheelchair is between zero degrees and thirty degrees. This angle provides an ergonomic advantage to the attendant on the front side of the wheelchair. The hand holding member may also contain various configurations to facilitate the ergonomic use of the wheelchair attachment apparatus.

In a preferred embodiment, the wheelchair contains a front frame member that spans the two front vertical frame members. The frame member may consist of various configurations, including a single horizontal bar member, a double horizontal bar member, two bar members that criss-cross. The front frame member may be configured to fold when the wheelchair is folded, such as a scissors-type mechanism for the criss-cross configuration. The front frame member preferably contains two receiving members where the ends of the connecting arm members can be inserted and attached to the frame of the wheelchair. Once attached to the front frame member, the hand hold member and connecting arm members can be used to lift or otherwise maneuver the occupied wheelchair.

In a preferred embodiment, the wheelchair lift apparatus is operably connected to the wheelchair by two receiving members that are each attached to a front frame member and that operably receive the connecting arm members. In some aspects, the two receiving members are comprised of brackets that are attachable and detachable to the front frame members and located below a plane defined by the seat. In some other aspects, each of the two respective receiving members are integral with at least the respective front frame member. In some other aspects, each of the two respective receiving members are integral with the respective front frame member and a respective back frame member. In some aspects, the two receiving members are located between the two front frame members, the front frame members extending away from the seat in a direction towards the ground during a normal mode of operation. In some aspects, the wheelchair lift apparatus is adjustable between a retracted position and an extended operative position. In some other aspects, the two receiving members are located proximate the two front frame members and below a plane defined by the seat. In some aspects, the hand hold member is adjustable to accommodate different widths of wheelchairs. When the wheelchair lift apparatus is connected to the wheelchair, the attendant can lift up on the hand hold member to lift or other maneuver the front side of a wheelchair while another attendant uses the standard handles on the backside of the wheelchair.

In a preferred embodiment, the wheelchair attachment portion is attachable and detachable to the two receiving members, such that the wheelchair lift apparatus may be optionally removed from the wheelchair when not needed and then operably attached to the wheelchair when needed for normal mode of operation. In some aspects, the front frame members may consist of various configurations, including front frame members that are parallel, diverging as they extend away from the seat and towards the ground, and converging as they extend away from the seat and towards the ground. In some aspects, the front frame members preferably contain two receiving members where the ends of the connecting arm members can be inserted and attached to the frame of the wheelchair. Once attached to the front frame member, the hand hold member and connecting arm members can be used to lift or otherwise maneuver the occupied wheelchair.

Accordingly, there has been provided a wheelchair attachment apparatus, a permanent wheelchair apparatus, and associated method for lifting or otherwise maneuvering a wheelchair. The wheelchair attachment apparatus is capable of being attached to a wheelchair for use, detached from the wheelchair, and alternatively stored on the wheelchair when not used. The attachment apparatus is also capable of being used simultaneously with wheelchair attachments, such as foot/leg supports. The permanent wheelchair apparatus is capable of operably receiving a lifting mechanism that can be attached, detached, and alternatively stored on the wheelchair when not used. Other attributes and benefits of the foregoing will be apparent to one of ordinary skill in the art from the following drawings and detailed description.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of a conventional wheelchair prior to the present invention being operably attached thereto;

FIG. 2A is a perspective view of a wheelchair lifting attachment apparatus in accordance with the teachings of the present invention;

FIG. 2B is a perspective view of the wheelchair lifting attachment apparatus of FIG. 2A shown in the operative mode operably attached to a conventional wheelchair;

FIG. 3A is a perspective view of another embodiment of the wheelchair lifting attachment apparatus in accordance with the teachings of the present invention;

FIG. 3B is an exploded perspective view of the wheelchair lifting attachment apparatus embodiment of FIG. 3A;

FIG. 3C is a perspective view of the wheelchair lifting attachment apparatus of FIG. 3A shown in the operative mode operably attached to a conventional wheelchair;

FIG. 4A is an exploded perspective view of another embodiment of the wheelchair lifting attachment apparatus in accordance with the teachings of the present invention;

FIG. 4B is a perspective view of the wheelchair lifting attachment apparatus of FIG. 4A shown in the operative mode operably attached to a conventional wheelchair;

FIG. 5A is a perspective view of another embodiment of the wheelchair lifting attachment apparatus in accordance with the teachings of the present invention;

FIG. 5B is an exploded perspective view of the wheelchair lifting attachment apparatus embodiment of FIG. 5A;

FIG. 5C is a perspective view of the wheelchair lifting attachment apparatus of FIG. 5A shown in the operative mode operably attached to a conventional wheelchair;

FIG. 6A is a perspective view of another embodiment of the wheelchair lifting attachment apparatus in accordance with the teachings of the present invention;

FIG. 6B is an exploded perspective view of the wheelchair lifting attachment apparatus embodiment of FIG. 6A;

FIG. 6C is a perspective view of the wheelchair lifting attachment apparatus of FIG. 6A shown in a retracted operative mode operably attached to a conventional wheelchair;

FIG. 6D is a perspective view of the wheelchair lifting attachment apparatus of FIG. 6A shown in an extended operative mode operably attached to a conventional wheelchair;

FIGS. 7A-7G is a front elevation view of the arm levers in various configurations in accordance with the teachings of the present invention.

FIG. 8A is a front view of the front lower side portion of a wheelchair in accordance with the teachings of the present invention;

FIG. 8B is a front view of the front lower side portion of a wheelchair in accordance with the teachings of the present invention;

FIG. 8C is a front view of the front lower side portion of a wheelchair in accordance with the teachings of the present invention;

FIG. 9 is a perspective view of the lower portion of a conventional wheelchair having two receiving members attached to the front of the wheelchair proximate the front frame members, each of the two receiving members capable of operably receiving a connecting arm member of a wheelchair lift apparatus in accordance with the teachings of the present invention;

FIG. 10 is a perspective-exploded view of the lower portion of a wheelchair having two integral receiving members connected to the front of the wheelchair proximate the front frame members, each of the two receiving members capable of operably receiving a connecting arm member of a wheelchair lift apparatus in accordance with the teachings of the present invention;

FIG. 11 is a perspective view of the lower portion of a wheelchair having two integral receiving members connected to and spanning the front and back frame members of the wheelchair, each of the two receiving members capable of operably receiving a connecting arm member of a wheelchair lift apparatus in accordance with the teachings of the present invention;

FIG. 12 is a perspective view of a bracket configuration that is connected to the receiving member (not-shown) in accordance with the teachings of the present invention;

FIG. 13 is a perspective view of a bracket configuration that is connected to the receiving member (not-shown) in accordance with the teachings of the present invention;

FIG. 14 is a perspective view of a bracket configuration that is connected to the receiving member (not-shown) in accordance with the teachings of the present invention;

FIG. 15 is a side view of an attachable receiving member configuration, the attachable receiving member connected to the frame of a wheelchair in accordance with the teachings of the present invention;

FIG. 16 is a top view of an adjustable hand hold member for accommodating wheelchairs with different widths in accordance with the teachings of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

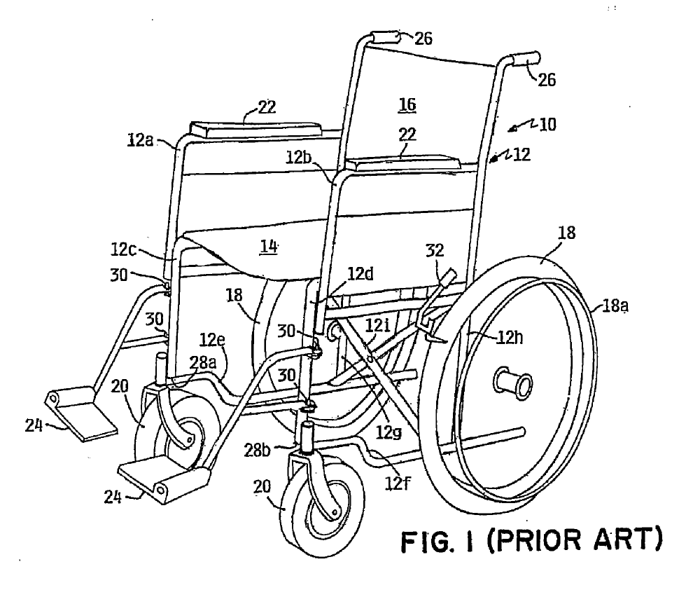

Referring now to the several Figures wherein like numerals indicate like parts. A conventional wheelchair 10 is illustrated in FIG. 1, which generally comprises a frame 12, a seat 14 and back-support 16 connected to the frame 12, two large rear wheels 18 connected to the frame 12 for directly supporting the weight of the wheelchair occupant, a pair of small front wheels 20 swivelably mounted to the frame 12, arm support structures 22, foot/leg support structures 24, and a pair of spaced apart handgrips 26 connected to the upper rear part of the frame 12 for being grasped by an attendant to thereby enable the attendant to push and guide the wheelchair from the rear. The two large rear wheels 18 may also contain an outer ring 18a, which may be grasped and rotated by the wheelchair occupant to move the wheelchair carrying the occupant. Each of the leg support structures 24 may be permanently attached to the front frame members 12c, 12d, or alternatively, the leg support structures 24 may be operably attachable and removable from the front frame members 12c, 12d by leg attachment means 30, such as pins that are attached to the front frame members 12c, 12d, foot rest or leg rest attachment brackets, or other attachment means currently used with conventional wheelchairs 10. The wheelchair 10 may also contain one or more hand-breaks 32 proximate the two large rear wheels 18 for locking the wheelchair 10 in a stationary position.

The frame can take various forms, but typically provides a pair of tubular side frames 12a, 12b that are cross-connected in some manner such as illustrated in FIG. 1. In foldable wheelchairs, wherein the seat 14 and back-rest 16 are provided in material that may be folded such as canvas or other cloth-like material, the cross-connection between the side frames 12a, 12b is some scissor-mechanism 12i that allows the wheelchair 10 to be opened in an extended position or closed in a folded position. In some form or another, the wheelchair 10 is configured such that the side frames 12a, 12b will incorporate some structure that defines the forward, generally vertical corners of the wheelchair, such as front frame members 12c, 12d that run in a generally vertical direction between each of the arm support structures 22 and ending proximate each of the small front wheels 20. The end of the front vertical frame 12a, 12b proximate the small front wheels 20 contains a tubular aperture 28a, 28b on each lower front side of the wheelchair 10. The frame may also contain a lower horizontal frame portion 12e, 12f that extends between the end of the front frame members 12c, 12d proximate the tubular apertures 28a, 28b and the vertical wheel support frame 12g, 12h proximate the two large rear wheels 18.

Because of the general configuration of a conventional wheelchair 10, one or more attendants will have difficulty in lifting and maneuvering an occupied wheelchair to go up and/or down a flight of stairs. This difficulty increases when the wheelchair occupant is of any substantial size, the attendant is not physically strong compared to the weight of the occupied wheelchair, the flight of stairs is relatively steep, or the like. If the attendant were to attempt to lift an occupied wheelchair up a flight of stairs, the attendant would most likely tilt the occupied wheelchair backwards lifting the front wheels 20 off of the ground, and walk backwards up the stairs while simultaneously pulling up on the handgrips 26 to lift the larger rear wheels 18 up each individual stair. In most instances, the attendant would be assisted by one or more attendants that would grasp and lift the wheelchair by either the lower horizontal frame portion 12e, 12f, the leg support structures 24, the swivel wheels 20, or the like. The attendant maintaining the handgrips 26 may alternatively walk frontwards up the stairs while one or more assistants grasp a front portion of the wheelchair and walk backwards up the flight of stairs. In going down a flight of stairs, the same type of technique may be utilized, except the occupied wheelchair would be assisted down the flight of stairs by the one or more attendants. In any event, the assisting attendant on the front side of the wheelchair is not able to grab any meaningful structural member that is intended to help the attendant lift or otherwise maneuver the wheelchair.

In a preferred embodiment, the wheelchair attachment apparatus of the present invention is designed to detachably mount to the wheelchair structure that defines the wheelchair's front lower corners, such as members 28a, 28b and 12c, 12d. The detachably mounted attachment apparatus of the present invention allows a single attendant to easily grasp and control the front side of an occupied wheelchair while one or more attendants use the handgrips 26 to traverse a flight of stairs.

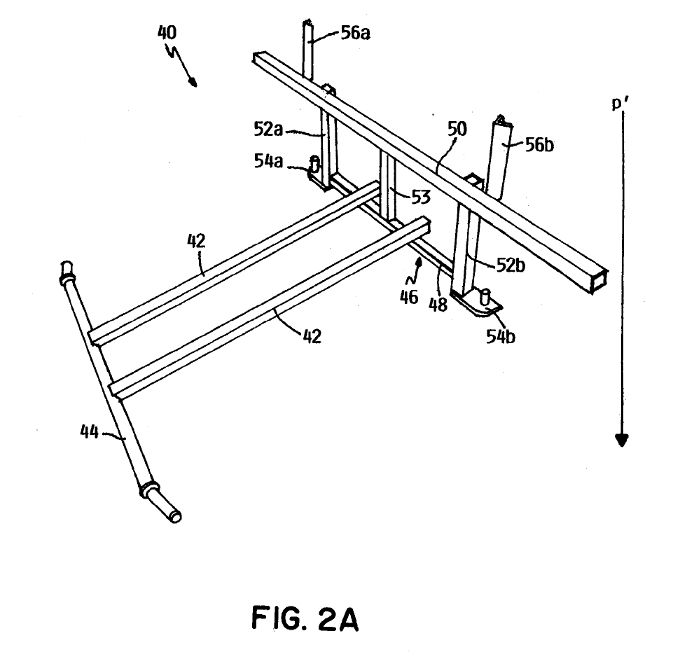

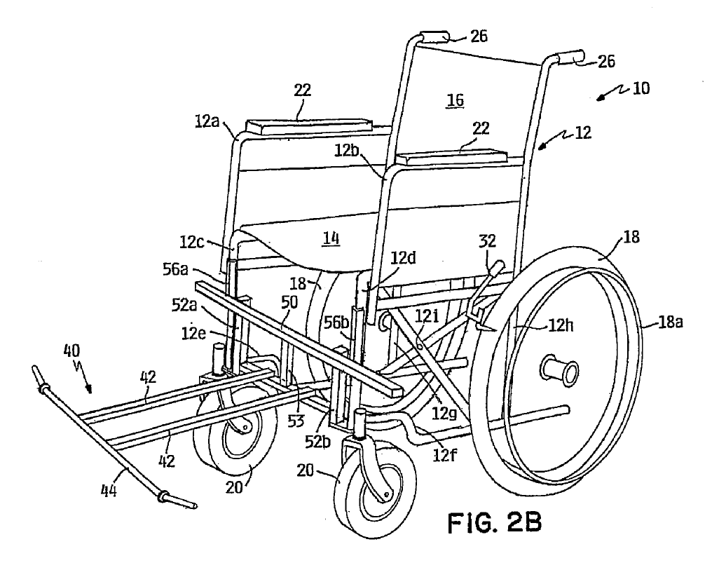

Referring now to the embodiment shown in FIGS. 2A-2B, the wheelchair lift attachment apparatus 40 of the present invention comprises a pair of connecting arm members 42 located between a lifting or handhold member 44 and a wheelchair connection portion 46. The wheelchair connection portion 46 comprises a lower horizontal member 48 spaced apart from an upper horizontal member 50 connected by two outer vertical support members 52a, 52b. The wheelchair connection portion 46 of the present embodiment also contains a centrally located vertical support member 53 that connects the lower horizontal member 48 and the upper horizontal member 50 and is vertically spaced from the vertical support members 52a, 52b. In other preferred embodiments, the wheelchair connection portion 46 may contain more than one vertical support member 53, or alternatively, the wheelchair connection portion may not contain a vertical support member 53. In the embodiment shown in FIGS. 2A-2B, connected to the vertical support members 52a, 52b and located at an end of the vertical support members 52a, 52b opposite the connection of the vertical support members 52a, 52b to the lower horizontal member 48 are two extending members with vertical plugs 54a, 54b that operably engage the tubular apertures 28a, 28b of a conventional wheelchair 10. Extending from the upper horizontal member 50 are two vertical frame engaging members 56a, 56b. As shown in FIG. 2A, the lower horizontal member 48 and upper horizontal member 50 are preferably arranged in a parallel configuration with each other. FIG. 2A also illustrates the vertical support members 52a, 52b, the centrally located vertical support member 53, the lower horizontal member 48, the plugs 54a, 54b, and the vertical frame engaging members 56a, 56b are arranged in the same vertical plane (P′). In an alternative preferred embodiment, the upper horizontal member 50 is also attached to the vertical support members 52a, 52b in such a configuration to also be in vertical plane (P′). In this alternative preferred embodiment, the two vertical frame engaging members 56a, 56b would extend from the top portion of the upper horizontal member 50, rather than the inside portion, to enable the two vertical frame engaging members 56a, 56b to be in vertical plane (P′).

As illustrated in FIG. 2B, the two vertical frame engaging members 56a, 56b are spaced apart a distance such that they engage the front frame members 12c, 12d, respectively, when the wheelchair lift attachment apparatus 40 is detachably mounted to the wheelchair 10. Also as illustrated in FIG. 2B, the vertical plugs 54a, 54b insert into and operably engage the tubular apertures 28a, 28b of the conventional wheelchair 10. The pair of connecting arm members 42, lifting member 44, and the wheelchair connection portion 46 are also configured such that the pair of connecting arm members 42 are located at an angle that is preferably between 0° and 40° relative to the ground, and optimally between 10° and 30°, with other subranges of the foregoing ranges contemplated and considered part of the foregoing disclosure.

As illustrated by the manual wheelchair lift attachment 40 being detachably mounted to the wheelchair 10 in FIG. 2B, the distance between the vertical frame engaging members 56a, 56b is the same as the distance between the plugs 54a, 54b as a result of the parallel, vertical relationship between the front frame members 12c, 12d and the resulting tubular apertures 28a, 28b at the end of the front frame members 12c, 12d. The front frame members 12c, 12d are dependent upon the size of the wheelchair 10, which typically range from 14 inches to 30 inches in width. As illustrated in FIG. 2B, the vertical support members 52a, 52b are spaced apart on the lower horizontal member 48 a distance less than the distance between the vertical frame engaging members 56a, 56b and also the plugs 54a, 54b. The upper horizontal member 50 is preferably longer in length than the distance between the front frame members 12c, 12d, which ranges from 14 inches to 30 inches on standard wheelchairs. As such, different sized wheelchair attachments 40 are contemplated by the present invention.

In a preferred embodiment, the vertical frame engaging members 56a, 56b extend a distance between ½ inch to about 5 inches, and more optimally between 1 and 3 inches with other subranges of the foregoing ranges contemplated, away from the upper horizontal member 50 in an upward direction. As illustrated in FIG. 2B, the vertical frame engaging members 56a, 56b have a concave engaging region that operably engages with the tubular nature of the respective front frame members 12c, 12d. In order to provide the concave engaging region of the vertical frame engaging members 56a, 56b, the vertical frame engaging members 56a, 56b may be angled, arcuate or otherwise shaped to operably engage with the front frame members 12c, 12d.

In a preferred embodiment, the plugs 54a, 54b extend a distance between ½ inch to about 3 inches into the tubular apertures 28a, 28b, and optimally about 1 inch to about 2 inches. Other subranges of the foregoing ranges are contemplated in the present invention. The plugs 54a, 54b also preferably have a diameter such that the plugs 54a, 54b slide into the tubular apertures 28a, 28b. Preferably, the plugs 54a, 54b fit easily, but yet snuggly, within the tubular apertures 28a, 28b to operably engage with the wheelchair 10.

In a preferred embodiment, the upper horizontal member 50 extends a distance at least as wide as the width of the front frame members 12c, 12d, and preferably a ½ inch up to about 5 inches wider than the width of the front frame members 12c, 12d, and optimally a ½ inch to about 2 inches wider than the width of the front frame members 12c, 12d, such that the upper horizontal member 50 also operably engages with the front frame members 12c, 12d when the manual wheelchair lift attachment 40 is detachably mounted to the wheelchair 10.

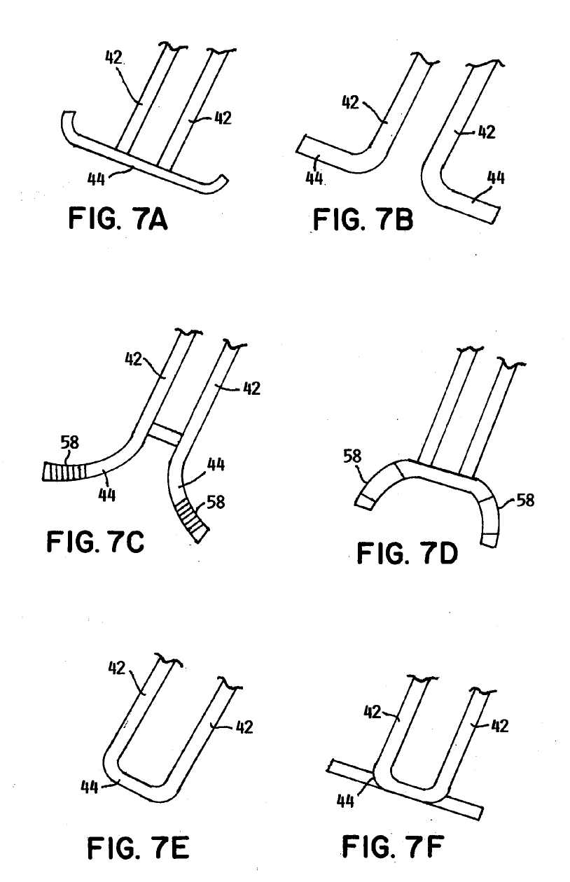

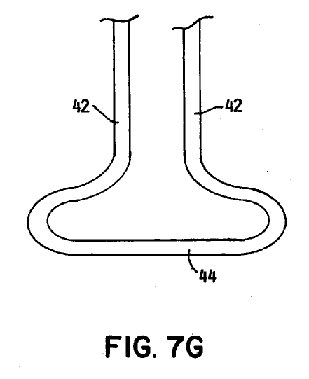

In a preferred embodiment, the connecting arm members 42 extend the lifting member 44 away from the wheelchair connection portion 46 a distance between six inches and four or more feet, and more optimally between about 1 foot and about 3 feet. In one embodiment, the lifting member 44 may be wider than the width of the wheelchair, and in an alternative embodiment, the lifting member 44 is significantly narrower than the width of the wheelchair. As such, it is contemplated that the lifting member 44 of the present may have a width that ranges from six inches to three feet, optimally 1 foot to 3 feet, and more optimally about 2 feet. As illustrated in FIG. 7, the lifting member 44 may also have various configurations, and may optionally include hand grips 58.

The detachably mounted attachment apparatus of the present invention allows a single attendant to easily grasp and control the front side of an occupied wheelchair while another attendant uses the handgrips 26 of the wheelchair 10 to traverse a flight of stairs. To attach the wheelchair lift attachment apparatus 40 to a wheelchair, the wheelchair lift attachment apparatus 40 is maneuvered such that the plugs 54a, 54b are inserted into the tubular apertures 28a, 28b, and the upper horizontal member 50 and the vertical frame engaging members 56a, 56b engage the front frame members 12c, 12d of the wheelchair 10. For insertion of the plugs 54a, 54b into the respective tubular apertures 28a, 28b, the small front wheels 20 may need to be swiveled to fully expose the tubular apertures 28a, 28b. Once the wheelchair lift attachment apparatus 40 is detachably mounted, the attendant uses the lifting member 44 to lift and/or maneuver the front side of the occupied wheelchair while another attendant uses the handgrips 26 to lift and/or maneuver the back side of the occupied wheelchair. Either the attendant using the handgrips 26 or the attendant with the lifting member 44 may traverse up or down the stairs first, although preferably the attendant with the lifting member 44 is located on the downside of the stairs.

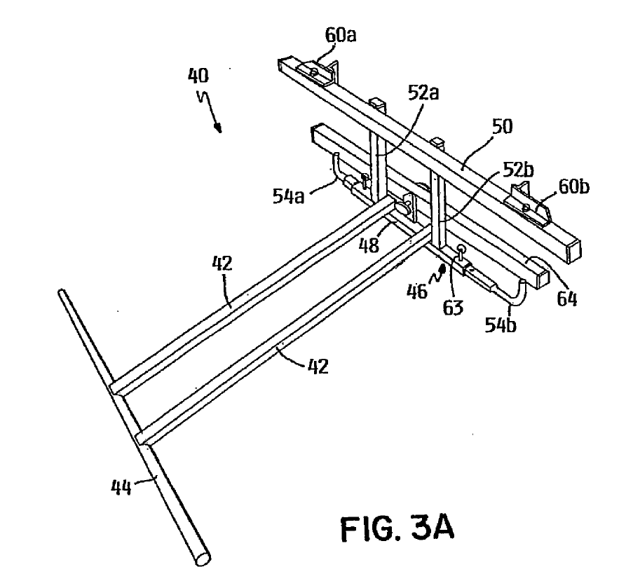

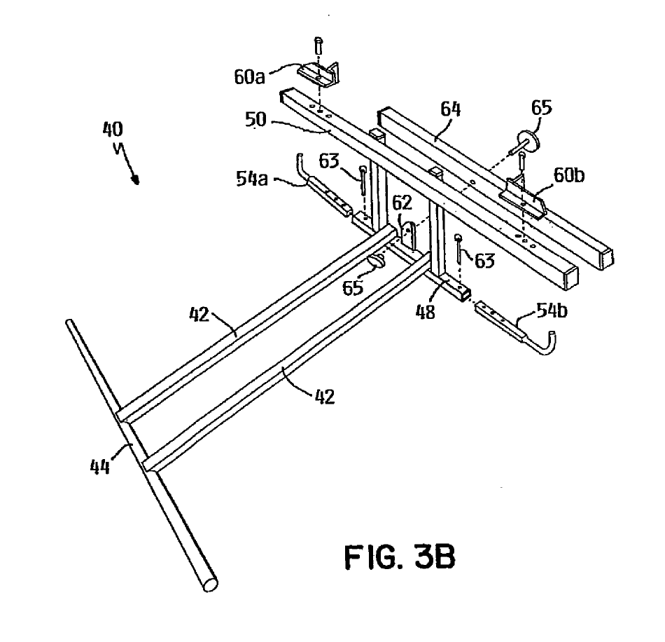

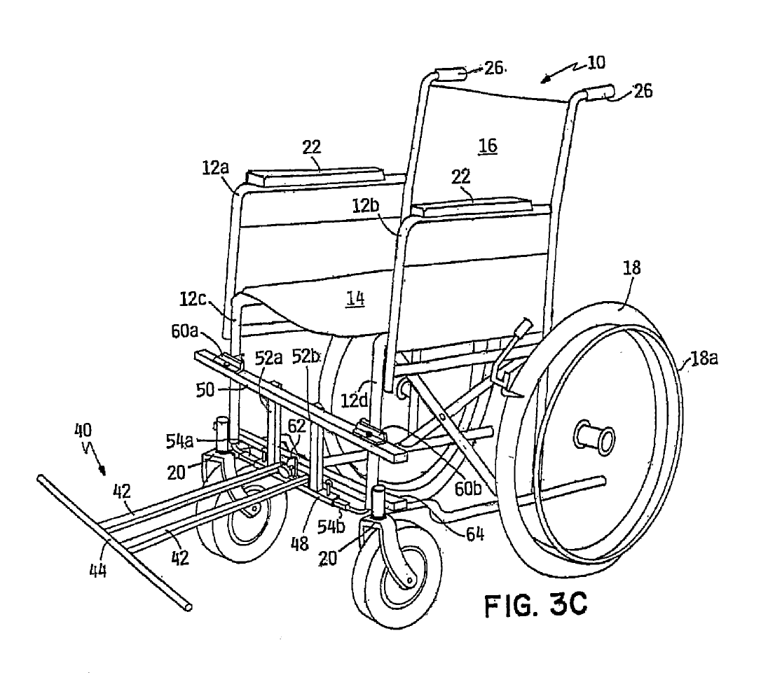

Referring now to FIGS. 3A-3C, another preferred embodiment of the present invention is illustrated. The wheelchair lift attachment apparatus 40 of the present invention comprises a pair of connecting arm members 42 located between a lifting or hand hold member 44 and a wheelchair connection portion 46. In this preferred embodiment, the lifting handhold member is illustrated as being straight, although other acceptable configurations may used with this preferred embodiments, such as those configurations illustrated in FIGS. 7A-7G. The wheelchair connection portion 46 comprises a lower horizontal member 48 spaced apart from an upper horizontal member 50 connected by two outer vertical support members 52a, 52b. Located outside the vertical support members 52a, 52b and proximately connected to the lower horizontal member 48 are two extending members with vertical plugs 54a, 54b that operably engage the tubular apertures 28a, 28b of a conventional wheelchair 10. In this preferred embodiment, both of the extending members with vertically extending plugs 54a, 54b are slidably adjustable with respect to the lower horizontal member 48 to accommodate different sized wheelchairs. Once the desired width of the vertically extending plugs 54a, 54b with respect to the lower horizontal member 48 are determined, a locking means such as one or more pins 63 is inserted through the corresponding apertures on the lower horizontal member 48 and the extending members with vertically extending plugs 54a, 54b. One of ordinary skill in the art will appreciate that other locking means, for example screws, bolts and spring-biased plugs or the like, are contemplated and are within the scope of the present invention.

The upper horizontal member 50 also contains bench members 60a, 60b, which in this preferred embodiment are operably attached and adjustable. In another preferred embodiment, the bench members 60a, 60b are permanently attached to the upper horizontal member 50. The adjustable bench members 60a, 60b in this preferred embodiment illustrated in FIGS. 3A-3C, may be operably fastened to the upper horizontal member 50 by fastening means, such as a pin or other acceptable fastening means as previously discussed and known to one of ordinary skill in the art, that inserts through the corresponding apertures in the respective bench member 60a, 60b and the upper horizontal member 50. The bench members 60a, 60b which are generally “L”shaped such as to operably engage two sides of the front frame members 12c, 12d of the wheelchair 10 as illustrated in FIG. 3C, which prevents the wheelchair 10 from unintentionally collapsing into a folded state. In another preferred embodiment, the bench members 60a, 60b contain a different shape, such as “T” shaped, while still operably engaging two sides of the front frame members 12c, 12d of the wheelchair 10 when in use. Bench members that are adjustable allow the wheelchair lift attachment 40 to be used with different sized wheelchairs 10 without compromising the additional provided support. In an alternative preferred embodiment, the bench members 60a, 60b may contain two or more portions that extend towards the wheelchair 10 wherein such inwardly extending portions of bench members 60a, 60b are spaced at intervals of about an inch, or slightly wider than the front frame members 12c, 12d, to accommodate different sized wheelchairs. Such spaced intervals allow the same benches to be used on different sized wheelchairs without the need to adjust the bench members 60a, 60b with respect to the upper horizontal member 50, although such bench members with multiple inwardly extending portions may also be adjustable.

In the preferred embodiment illustrated in FIGS. 3A-3C, the front portion of the “L” shaped bench members 60a, 60b, which is in the same vertical plane as the upper horizontal member 50, preferably extends a distance between ½ inch to about 5 inches away from the upper horizontal member 50 in an upward direction, and more optimally between 1 and 3 inches with other subranges of the foregoing ranges contemplated. Additionally, the front portion of the “L” shaped bench members 60a, 60b are preferably about ½ inch to about 3 inches wide, and more optimally between 1 and 2 inches wide with other subranges of the foregoing ranges contemplated. The inner portion of the “L” shaped bench members 60a, 60, which is perpendicular to the upper horizontal member 50, preferably extends a distance between ½ inch to about 5 inches away from the upper horizontal member 50 in an upward direction, and more optimally between 1 and 3 inches with other subranges of the foregoing ranges contemplated. Additionally, the inner portion of the “L” shaped bench members 60a, 60, preferably extends a distance between ½ inch to about 3 inches away from the upper horizontal member 50 in direction towards the backside of the wheelchair 10, and more optimally about 1 inch to about 2 inches with other subranges of the foregoing ranges contemplated. The front portion and the inner portion of the “L” shaped bench members 60a, 60b extending upward away from the upper horizontal member 50 are preferably the same dimensions, but in an alternative preferred embodiment are different sizes.

The wheelchair connection portion 46 of the preferred embodiment in FIGS. 3A-3C also contains a central attachment member 62 with a corresponding backing bar member 64 that operably connects thereto. The backing bar member 64 can be operably attached to the wheelchair lift attachment 40 by a fastening member 65 that fits through the apertures in the central attachment member 62 and the backing bar member 64, as illustrated in FIG. 3B. In a preferred embodiment, the backing bar member 64 is the same length as the upper horizontal member 50. Both the backing bar 64 and the upper horizontal member 50 are preferably equal in length or longer than the distance between the front frame members 12c, 12d of the wheelchair 10, which ranges from 14 inches to 30 inches on standard wheelchairs. In another alternative preferred embodiment, the backing bar member 64 and the upper horizontal member 50 are different lengths.

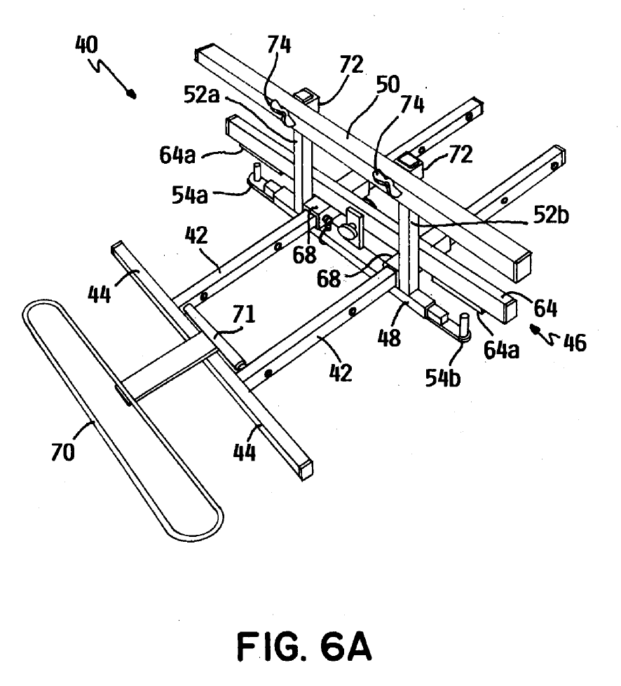

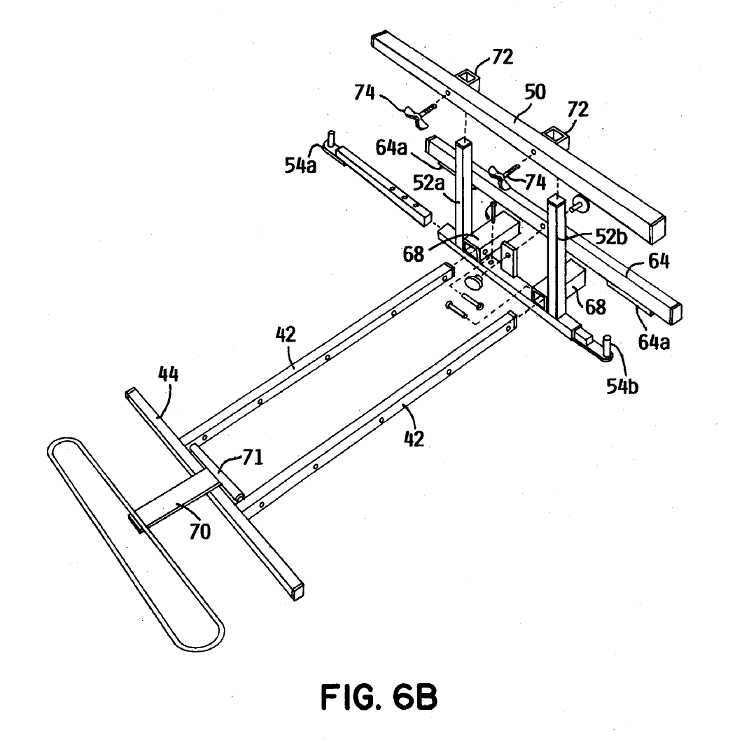

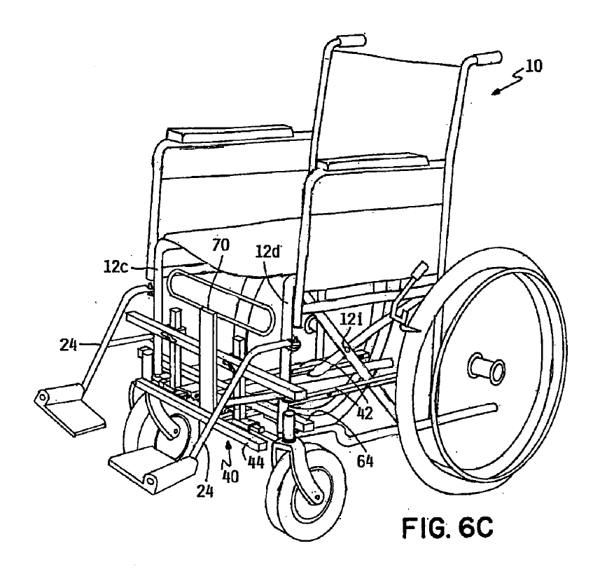

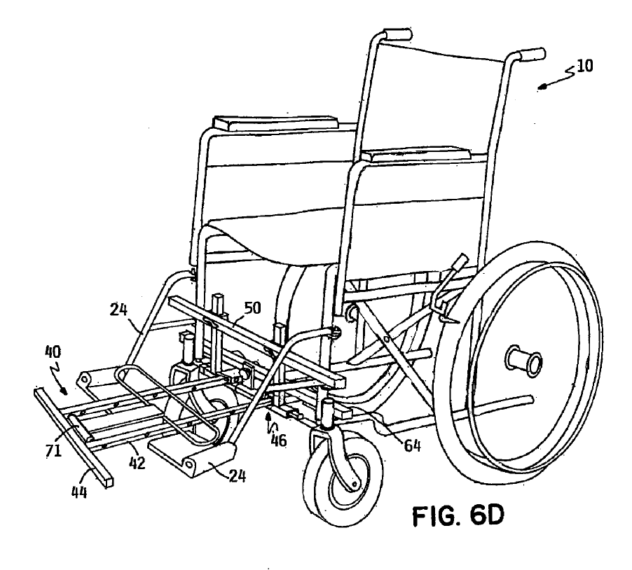

In a further alternative preferred embodiment, the backing bar member 64 is telescopically adjustable to expand or contract into different lengths. In one such preferred embodiment, both ends of the backing bar member 64 are adjustable such that both ends operably engage with a central portion, such as the adjustable extending plugs 54a, 54b and lower horizontal member 48 configuration shown in FIGS. 3A and 3B, except the adjustable ends of the backing bar member 64 may either include or not include the curved plug-type configuration. In another preferred embodiment, there are only two pieces that extend and are adjustable with respect to each other, such as the adjustable extending plugs 54a, 54b and lower horizontal member 48 configuration shown in FIGS. 6A-6B. When the ends of the backing bar member 64 include a curved plug-type configuration, the backing bar member 64 would be adjusted such that the plug-type configurations operably engage the outside edge of the front frame members 12c, 12d or the frame portion of the small swivel wheels 20 of the wheelchair 10 (not shown).

Referring now to the preferred embodiment illustrated in FIG. 3C, when the wheelchair lift attachment apparatus 40 is detachably mounted to the wheelchair 10, the backing bar member 64 provides additional support. Particularly, the backing bar member 64 is placed on the back side of the front frame members 12c, 12d such that when it is secured to the central attachment member 62 by fastening member 65, compression pressure is exerted both on the backside of the front frame members 12c, 12d of the wheelchair 10 by the backing bar member 64 and the front side by the upper horizontal member 50. The compression pressure that is exerted is a result of the front frame members 12c, 12d being sandwiched between the backing bar member 64 and at least the upper horizontal member 50 that engages with the front side of the front frame members 12c, 12d. In a preferred embodiment, the backing bar member 64 also rests on the top side of the lower horizontal frame portion 12e, 12f as shown in FIG. 3C to provide further support and safety measures. In an alternative embodiment not shown, the backing bar member 64 may provide even additional support by the use of a hooking member. In this alternative embodiment, the backing bar member 64 contains an aperture located at each end that allows preferably a straight threaded end of a hooking member to be inserted through and fastened to the backing bar member 64 while the hooking end of the hooking member operably engages and connects to the lower horizontal frame portion 12e, 12f of the wheelchair 10. Once the hooking end is operably engaged to the lower horizontal frame portion 12e, 12f, the threaded end is secured to the backing bar member 64 by fastening means to secure the backing bar member 64 to the lower horizontal frame portion 12e, 12f.

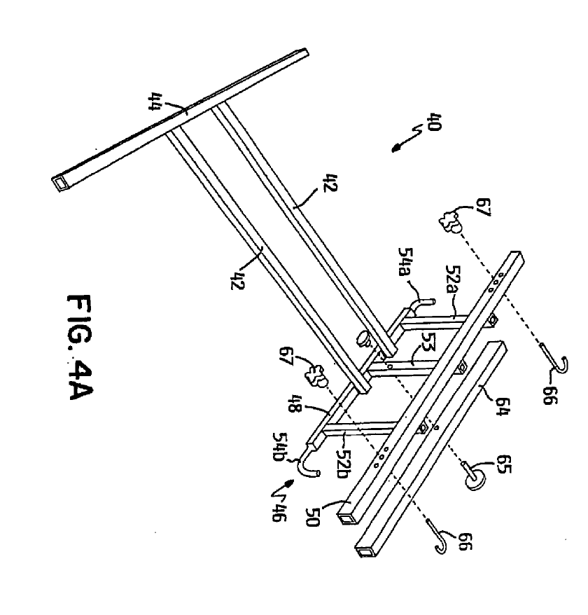

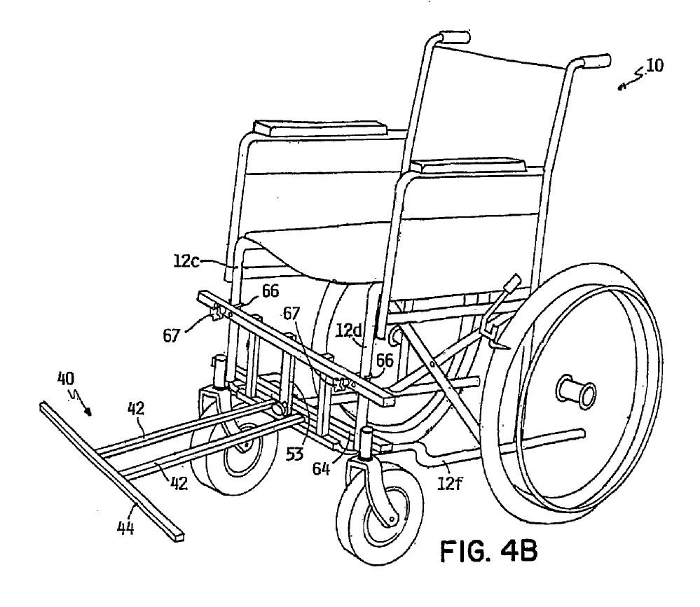

Referring now to FIGS. 4A-4B, another preferred embodiment of the present invention is illustrated. The wheelchair lift attachment apparatus 40 of the present invention comprises a pair of connecting arm members 42 located between a lifting or handhold member 44 and a wheelchair connection portion 46. Like the foregoing preferred embodiments, the wheelchair connection portion 46 comprises a lower horizontal member 48 spaced apart from an upper horizontal member 50 connected by two vertical support members 52a, 52b and a central located vertical support member 53. As illustrated in this preferred embodiment, it is contemplated that the lower horizontal member 48 and upper horizontal member 50 may be spaced apart by more than two vertical support members.

Located outside the vertical support members 52a, 52b and proximately connected to the lower horizontal member 48 are two extending members with vertically extending plugs 54a, 54b that operably engage the tubular apertures 28a, 28b of a conventional wheelchair 10. In this preferred embodiment, the wheelchair connection portion 46 also contains a backing bar member 64 that operably attaches to the vertical support member 53. In still another alternative preferred embodiment, the backing bar member 64 attaches to one or more vertical support members 52a, 52b that contain an aperture that corresponds with the fastening member 65, which could be in addition to or as an alternative to the backing bar member 64 operably attaching to a vertical support member 53 or central vertical support member 53. In each of these preferred embodiments, the backing member 64 provides additional support and security measures to the wheelchair lift attachment 40 by virtue of the exerted compression on both the front side and the back side of the front frame members 12c, 12d as previously discussed. Additionally, the backing bar member 64 may optionally contains hooking members that operably engage and connects to the lower horizontal frame portion 12e, 12f of the wheelchair 10 by compression pressure for additional support and security measures as previously discussed.

In the preferred embodiment illustrated in FIGS. 4A and 4B, the upper horizontal member 50 also contains hooking members 66a, 66b which contain a hook configuration on the distal end and threads on the proximate end. In this preferred embodiment, the hook configuration on the distal end operably attaches to the front frame members 12c, 12d to provide additional support when the wheelchair lift attachment 40 is detachably mounted to the wheelchair 10, as shown in FIG. 4B. Preferably, the hooking members 66a, 66b maintain additional compression connection between the upper horizontal member 50 and the front frame members 12c, 12d by inserting the proximate threaded end through one of the apertures in the upper horizontal member 50 and fastening the hooking members 66a, 66b with fastening means, such as a threaded knob 67 as shown, or other fastenings such as a nut, wing-nut, or the like. The upper horizontal member 50 preferably contains multiple evenly spaced apertures for receiving the proximate threaded end of the hooking members 66a, 66b, which accommodates different sized wheelchairs. This preferred embodiment may also optionally contain one or more adjustable extending members with vertically extending plugs 54a, 54b with respect to the lower horizontal member 48 to accommodate different sized wheelchairs.

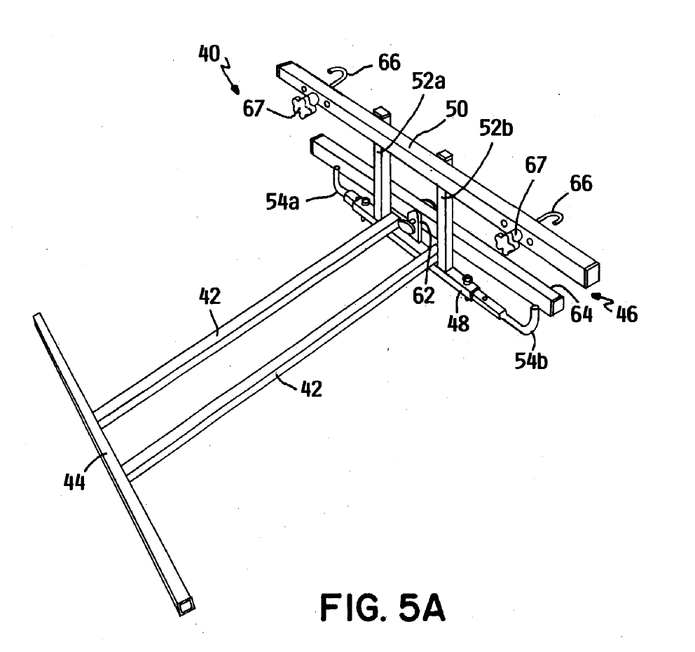

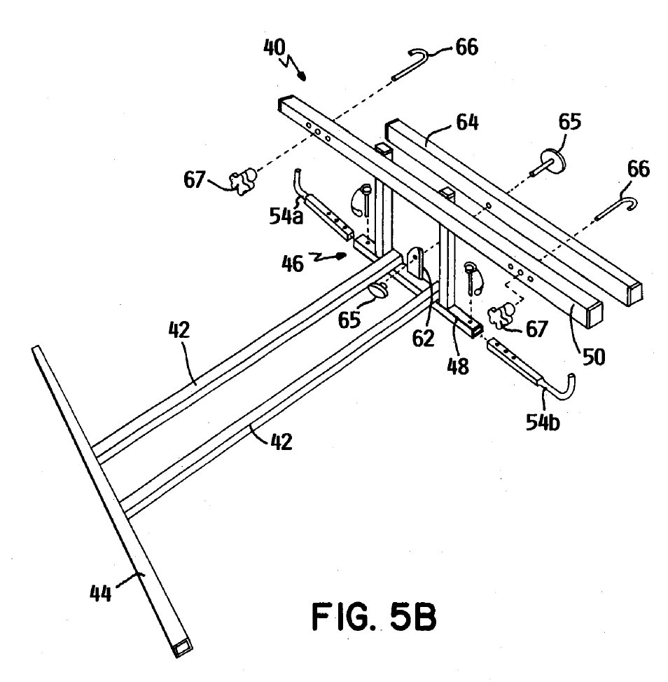

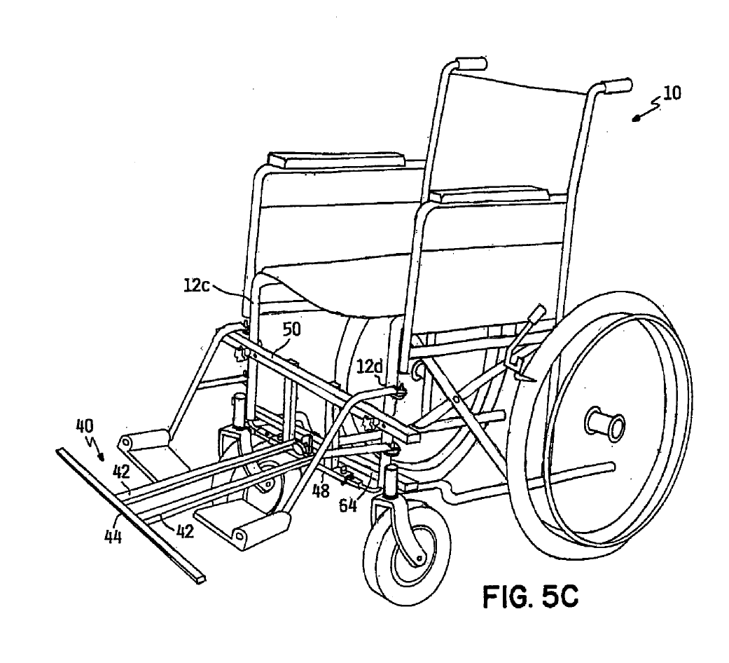

Referring now to FIGS. 5A-5C, another preferred embodiment of the present invention is illustrated. The wheelchair lift attachment apparatus 40 of the present invention comprises a pair of connecting arm members 42 located between a lifting or handhold member 44 and a wheelchair connection portion 46. Like the foregoing preferred embodiments, the wheelchair connection portion 46 comprises a lower horizontal member 48 spaced apart from an upper horizontal member 50 connected by two outer vertical support members 52a, 52b. Located outside the vertical support members 52a, 52b and proximately connected to the lower horizontal member 48 are two extending members with vertical plugs 54a, 54b that operably engage the tubular apertures 28a, 28b of a conventional wheelchair 10. In this preferred embodiment, both of the extending members with vertically extending plugs 54a, 54b are slidably adjustable with respect to the lower horizontal member 48 to accommodate different sized wheelchairs. Once the desired width of the vertically extending plugs 54a, 54b and lower horizontal member 48 are determined, a locking means such as one or more pins 63 is inserted through the corresponding apertures on the lower horizontal member 48 and vertically extending plugs 54a, 54b. One of ordinary skill in the art will appreciate that other locking means, for example screws, bolts and spring-biased plugs or the like, are contemplated and are within the scope of the present invention. The wheelchair connection portion 46 also preferably contains a backing bar member 64 that operably attaches to a central attachment member 62 as previously discussed.

The upper horizontal member 50 also preferably contains optional hooking members 66a, 66b, which contain a hook configuration on the distal end and threads on the proximate end. In this preferred embodiment, the hook configuration on the distal end operably attaches to the front frame members 12c, 12d to provide additional support when the wheelchair lift attachment 40 is detachably mounted to the wheelchair 10, as shown in FIG. 4B. Preferably, the hooking members 66a, 66b maintain additional compression connection between the upper horizontal member 50 and the front frame members 12c, 12d by inserting the proximate threaded end through one of the apertures in the upper horizontal member 50 and fastening the hooking members 66a, 66b with fastening means, such as a threaded knob 67 as shown, or other fastenings such as a nut, wing-nut, or the like. The upper horizontal member 50 preferably contains multiple evenly spaced apertures for receiving the proximate threaded end of the hooking members 66a, 66b, which accommodates different sized wheelchairs.

As illustrated in FIG. 5C, the wheelchair lift attachment apparatus 40 may be detachably mounted to the wheelchair 10 such that when mounted to the wheelchair 10 the wheelchair lift attachment 40 can be used simultaneously with the use of detachable foot/leg support structures 24 without interfering therewith. In this preferred embodiment, the connecting arm members 42 fit within the space between the foot/leg support structures 24 and the lifting or handhold member 44 is far enough away from the foot/leg support structures 24 such that an attendant may use the wheelchair lift attachment apparatus 40 without interfering with the legs or feet of the occupant. In another preferred embodiment, the wheelchair lift attachment apparatus 40 may be used with wheelchairs that contain permanent foot/leg support structures without interfering therewith.

As illustrated in FIGS. 3A-3C and FIGS. 5A-5C, the connecting arm members 42 may be connected to both the lower horizontal member 48 and an inner location of the vertical support members 52a, 52b, as opposed to just the lower horizontal member 48 as illustrated in FIGS. 2A-2B. Connecting the connecting arm members 42 to the lower horizontal member 48 and a vertical support member 52a, 52b provides additional support and load capacity for the connecting arm members 42. In an alternative preferred embodiment, the connecting arm members 42 are connected to both the lower horizontal member 48 and an outer location of the vertical support members 52a, 52b. Preferably, the connecting arm members 42 connect to the top portion of the lower horizontal member 48, although the connecting arm members 42 could connect to the front side or bottom portion of the lower horizontal member 48. In still another alternative preferred embodiment, the connecting arm member 42 may connect to any portion of the upper horizontal member 50, the vertical support members 52a, 52b, the vertical support member 53, or a combination of one or more of the foregoing. In still another preferred alternative embodiment, the connecting arm members 42 are replaced with a single connecting arm member 42.

Referring now to FIGS. 6A-6D, another preferred embodiment of the present invention is illustrated. The wheelchair lift attachment apparatus 40 of the present invention comprises a wheelchair connection portion 46 that is preferably detachably mounted to the wheelchair 10 independently from the connecting arm members 42 and lifting or handhold member 44. In this preferred embodiment, the connecting arm members 42 are connected to the handhold member 44 and are operably connectable and detachable to the wheelchair connection portion 46. Additionally, the connecting arm members 42 may adjustably slide into receiving members 68 located on the wheelchair connection portion 46 to allow the connecting arm members 42 to adjust to a retracted position as illustrated in FIG. 6C whereby at least a portion of the connecting arm members 42 may slide under the seat 14 of the wheelchair 10 proximate the scissor-mechanism 12i of the frame. The connecting arm members 42 may adjustably slide from the retracted position, FIG. 6C, to an extended operative position, FIG. 6D, or an intermediate position thereto. In either the retracted position or the extended position, the connecting arm members 42 may be locked in place by fastening means, such as a pin, nut and bolt, or the like. Alternatively, the connecting arm members 42 with the handhold member 44 may be disconnected from the receiving members 68 when not in an operational mode.

The receiving members 68 are preferably located on the top portion of the lower horizontal member 48 proximate the vertical support members 52a, 52b. The receiving members 68 may be located outside or inside the vertical support members 52a, 52b. In still another alternative preferred embodiment, the receiving members 68 may be located on any portion of the upper horizontal member 50, the vertical support members 52a, 52b, the vertical support member 53, or a combination of one or more of the foregoing. In still another preferred embodiment, one of ordinary skill in the art will appreciate that the connecting arm members 42 and lifting member 44 telescopically adjust between a retracted position and an extended position, or an intermediate position thereto, by telescoping means such as a telescoping handle used on luggage, which may be actuated by a push button, lever, or the like.

As illustrated in FIGS. 6A-6D, the connecting arm members 42 and lifting member 44 portion of the wheelchair lift attachment apparatus 40 may also have a foot support member 70. Preferably, the foot support member 70 adjusts between an extended position and a retracted position by a hinge-type mechanism 71. Alternatively, the foot support member 70 is in a fixed position relative to the lifting member 44 or the connecting arm members 42. The foot support 70 provides the occupant of the wheelchair with a position to place his/her feet both when the connecting arm members 42 are in the retracted position, extended position, or an intermediate position thereto.

The preferred embodiment illustrated in FIGS. 6A-6D also contains an adjustable upper horizontal member 50 relative to vertical support members 52a, 52b. In another alternative preferred embodiment, the adjustable upper horizontal member 50 adjusts relative to vertical support members 52a, 52b, the central vertical support member 53, or a combination thereof. The adjustable upper horizontal member 50 is preferably adjusted to the preferred location relative the vertical support members 52a, 52b and/or the vertical support member 53 by the receiving means 72. The vertical support members 52a, 52b and/or the vertical support member 53 are inserted within the receiving means 72 and a fastening member 74 fixes the upper horizontal member 50 in place once the preferred location of the upper horizontal member 50 is achieved. The fastening member 74 preferably comprises a threaded mechanism on the upper horizontal member 50 that receives a threaded fastener, such as a bolt or the like.

The adjustable horizontal member 50 allows the wheelchair lift attachment 40 to be used with various wheelchairs to avoid other attachments, such as permanent or detachable foot/leg support structures. As illustrated in FIG. 6C, the upper horizontal member 50 is adjusted such that it rests on top of the lower attachment portion of the foot/leg support structures 24. In this configuration, the engagement of the upper horizontal member 50 with the foot/leg support structures 24 and the front frame members 12c, 12d provides two axis of support when used in combination with the backing bar member 64. The backing bar member 64 may contain additional frame contacting portions 64a to accommodate the location of the receiving members 68 without compromising the additional support provided by interaction with the lower horizontal frame portion 12e, 12f. The upper horizontal member 50 may also contain vertical frame engaging members 56a, 56b, bench members 60a, 60b, hooking members 66a, 66b, or a combination thereof.

In this preferred embodiment, only one of the extending members with vertically extending plugs 54a, 54b is slidably adjustable, which may be either extending member although illustrated in FIG. 6B as being 54a. The single slidably adjustable extending member with vertical plug 54a (or 54b) accommodates different sized wheelchairs. Once the desired width of the extending members with vertically extending plugs 54a, 54b and lower horizontal member 48 are determined, a locking means such as a pin 63 is inserted through the corresponding aperture on the lower horizontal member 48 and the extending member with vertically extending plug 54a (or 54b). One of ordinary skill in the art will appreciate that other locking means, for example screws, bolts and spring-biased plugs or the like, are contemplated and are within the scope of the present invention. In an alternative preferred embodiment as previously discussed, both of the extending members with vertically extending plugs 54a, 54b are slidably adjustable.

The wheelchair connection portion 46 of the preferred embodiment also contains a central attachment member 62 with a corresponding backing bar member 64. The backing bar member 64 can be operably attached to the wheelchair lift attachment 40 by a fastening member 65 that fits through the apertures in the central attachment member 62 and the backing bar member 64. In a preferred embodiment, the backing bar member 64 is the same length as the upper horizontal member 50. Both the backing bar 64 and the upper horizontal member 50 are preferably equal in length or longer than the distance between the front frame members 12c, 12d of the wheelchair 10, which ranges from 14 inches to 30 inches on standard wheelchairs. In another alternative preferred embodiment, the backing bar member 64 and the upper horizontal member 50 are different lengths.

In a further alternative preferred embodiment, the backing bar member 64 and/or the upper horizontal bar 50 are telescopically adjustable to expand or contract into different lengths. In one such preferred embodiment, both ends of the backing bar member 64 and/or the upper horizontal bar 50 are adjustable such that both ends operably engage with a central portion, such as the adjustable extending plugs 54a, 54b and lower horizontal member 48 configuration shown in FIGS. 3A and 3B, except the adjustable ends of the backing bar member 64 and/or the upper horizontal bar 50 may either include or not include the curved plug-type configuration. In another preferred embodiment, there are only two pieces that extend and are adjustable with respect to each other, such as the adjustable extending plugs 54a, 54b and lower horizontal member 48 configuration shown in FIGS. 6A-6B. When the ends of the backing bar member 64 include a curved plug-type configuration, the backing bar member 64 would be adjusted such that the plug-type configurations operably engage the outside edge of the front frame members 12c, 12d or the frame portion of the small swivel wheels 20 of the wheelchair 10 (not shown). When the ends of the upper horizontal bar 50 include a curved plug-type configuration, the upper horizontal bar 50 would be adjusted such that the plug-type configurations operably engage the outside edge of the front frame members 12c, 12d.

As illustrated in FIGS. 6C-6D, when the wheelchair lift attachment 40 is detachably mounted to the wheelchair 10, the backing bar member 64 provides additional support to the wheelchair connection portion 46. Particularly, the backing bar member 64 is placed on the back side of the front frame members 12c, 12d such that when it is secured to the central attachment member 62 by fastening member 65, compression pressure is exerted both on the backside of the front frame members 12c, 12d of the wheelchair 10 by the backing bar member 64 and the front side by the upper horizontal member 50. The compression pressure that is exerted is a result of the front frame members 12c, 12d being sandwiched between the backing bar member 64 and at least the upper horizontal member 50 that engages with the front side of the front frame members 12c, 12d. In a preferred embodiment, the backing bar member 64 also rests on the top side of the lower horizontal frame portion 12e, 12f to provide further support and safety measures. As previously discussed, the backing bar member 64 may contain additional frame contacting portions 64a to accommodate the location of the receiving members 68 without compromising the additional support and safety measures provided by interaction with the lower horizontal frame portion 12e, 12f.

In another preferred embodiment, the upper horizontal member may contain vertical frame engaging members 56a, 56b, bench members 60a, 60b, hooking members 66a, 66b, or a combination thereof as previously discussed. Also, the backing bar member 64 may also contain hooking members as previously discussed.

In another preferred embodiment, the wheelchair connection portion 46 comprises a lower horizontal member 48 with two extending members with vertical plugs 54a, 54b that operably engage the tubular apertures 28a, 28b of a conventional wheelchair 10. The wheelchair connection portion 46 also comprises two angled extending members 76a, 76b that extend away from the lower horizontal member 48. Preferably, the two angled extending members 76a, 76b diverge away from each other as they extend from the lower horizontal member 48. In this preferred embodiment, each angled extending member 76a, 76b independently operably engages a front frame member 12c, 12d of the wheelchair 10. Each of the angled extending members 76a, 76b may also contain a vertical frame engaging member 56a, 56b, a bench member 60a, 60b, a hooking member 66a, 66b, or a combination thereof to secure the respective angled extending member 76a, 76b to the respective front frame members 12c, 12d. The vertical frame engaging members 56a, 56b, bench members 60a, 60b, and hooking members 66a, 66b may be adjustable on the angled extending members 76a, 76b. The wheelchair connection portion may also have a backing bar member 64 that operably engages with the angled extending members 76a, 76b, a central attachment member 62, or a combination thereof. In this preferred embodiment, due to the angled extending members 76a, 76b operably engaging with the front frame members 12c, 12d of the wheelchair 10, the upper horizontal member 50 of the foregoing described preferred embodiments may be eliminated.

In another preferred embodiment, the wheelchair connection portion 46 is permanently attached to the wheelchair such that it cannot be removed. In this preferred embodiment, the wheelchair connection portion 46 is welded or otherwise permanently fixed to the wheelchair 10. The connecting arm members 42 and lifting member 44 are preferably detachable from the permanently connected wheelchair connection portion 46, such as an adjustable or telescoping mechanism as previously discussed.

As illustrated in FIGS. 7A-7G, the connecting arm members 42 and lifting or handhold member 44 may contain various configurations. Such various configuration include the lifting member 44 having a shape that curves towards the wheelchair as illustrated in FIG. 7A; each connecting arm member 42 and lifting or handhold member 44 comprised of the same continuous material and not being connected proximate the lifting or handhold member 44 region as illustrated in FIG. 7B; each connecting arm member 42 and lifting or handhold member 44 comprised of the same continuous material and being connected proximate the lifting member 44 region as illustrated in FIG. 7C; the handhold member 44 having a shape that curves away from the wheelchair as illustrated in FIG. 7D; the connecting arm members 42 are comprised of the same continuous material to form a continuous handhold member 44 located between the connecting arm members 42 as illustrated in FIG. 7E; the connecting arm members 42 comprised of the same continuous material with additional material connected thereto such that the handhold member 44 is comprised of the material between the connecting arm members 42 and the additional material added thereto as illustrated in FIG. 7F; and the connecting arm members 42 comprised of the same continuous material to form a handhold member 44 located between and outside of the connecting arm members 42 as illustrated in FIG. 7G. The various connecting arm members 42 and lifting or handhold member 44 configurations may also include gripping means 58 to facilitate the grip of an attendant, such as handle grips, textured tape, foam, rubber, or other like material, as illustrated in FIGS. 7C and 7D.

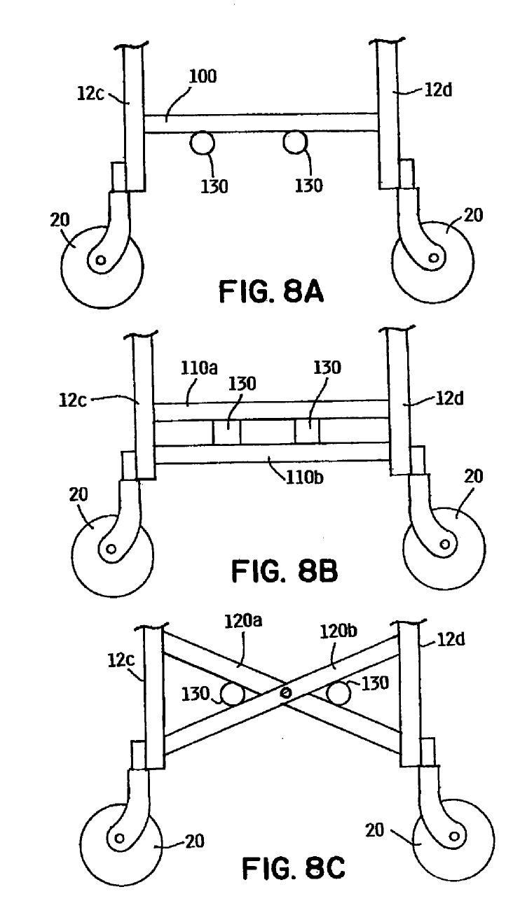

In another preferred embodiment, the wheelchair 10 contains one or more additional frame members spanning the distance between the lower horizontal frame members 12c, 12d proximate the front side of the wheelchair 10. Referring now to FIG. 8A is illustrated a single horizontal member 100 that spans the lower front side of the wheelchair 10 between the lower horizontal frame members 12c, 12d. In this preferred embodiment, the single horizontal member 100 comprises receiving members 130 for insertion of the ends of connecting arm members 42 connected to lifting or handhold member 44 can be inserted into. Preferably, the connecting arm members 42 are fastened into place when inserted into receiving members 130 for operational use. This may be accomplished by receiving members 130 and connecting arm members 42 containing corresponding apertures for insertion of a pin, bolt, spring-bolt, or the like fastening means. While the receiving members 130 are illustrated in a specific location with respect to the single horizontal member 100, it is contemplated in the present invention that the receiving members 130 may be located in alternative locations, such as the top portion. The receiving members 130 may also consist of various shapes to accommodate the shape of the one or more connecting arm members 42.

Referring now to FIG. 8B is two horizontal members 110a, 110b that span the lower front side of the wheelchair 10 between the lower horizontal frame members 12c, 12d. In this preferred embodiment, the two horizontal members 110a, 110b comprise receiving members 130 located between the two horizontal members 110a, 110b for insertion of the ends of connecting arm members 42. Preferably, the connecting arm members 42 are fastened into place when inserted into receiving members 130 for operational use. This may be accomplished by receiving members 130 and connecting arm members 42 containing corresponding apertures for insertion of a pin, bolt, spring-bolt, or the like fastening means. While the receiving members 130 are illustrated between the two horizontal members 110a, 110b, it is contemplated in the present invention that the receiving members 130 may be located in alternative locations, such as the top portion of horizontal bar 110a, the bottom portion of horizontal bar 110b, or the like. The receiving members 130 may also consist of various shapes to accommodate the shape of the one or more connecting arm members 42.

Referring now to FIG. 8C is two crossing members 120a, 120b that span the lower front side of the wheelchair 10 between the lower horizontal frame members 12c, 12d and that intersect with each other. In this preferred embodiment, each of the two cross members 120a, 120b comprise a receiving member 130 located in each angle of the intersecting portions of cross members 120a, 120b for insertion of the ends of connecting arm members 42. Preferably, the connecting arm members 42 are fastened into place when inserted into receiving members 130 for operational use. This may be accomplished by receiving members 130 and connecting arm members 42 containing corresponding apertures for insertion of a pin, bolt, spring-bolt, or the like fastening means. As discussed above, the receiving members are preferably located in the angle of the cross members 120a, 120b, which may be accomplished by each cross member 120a, 120b each containing a receiving member on the top portion or bottom portion. Alternatively, the back cross member 120a contains both receiving members 130 to prevent the wheelchair 10 from collapsing when the connecting arm members 42 are inserted into the receiving members 130 as a result of the connecting arm members 42 being between the cross members 120a, 120b. Alternatively, the receiving members 130 of the may be located in alternative locations, such as the top portion of one or both cross members 120a, 120b, the lower portion of one or both cross members 120a, 120b, or the like.

Referring to FIGS. 8A-8C, the connecting arm members 42 may be adjusted to a refracted position, such as illustrated in the detachable wheelchair lift attachment 40 as illustrated in FIG. 6C whereby at least a portion of the connecting arm members 42 may slide under the seat 14 of the wheelchair 10 proximate the scissor-mechanism 12i of the frame. The connecting arm members 42 may adjustably slide from the retracted position, FIG. 6C, to an extended operative position, FIG. 6D, or an intermediate position thereto. In either the retracted position, the extended position, or an intermediate position, the connecting arm members 42 may be locked in place by fastening means, such as a pin, nut and bolt, or the like. Alternatively, the connecting arm members 42 with the lifting or handhold member 44 may be disconnected from the wheelchair 10 altogether by removing the ends of the connecting arm members 42 from the receiving members 130 of the wheelchair 10 when not in an operational mode.

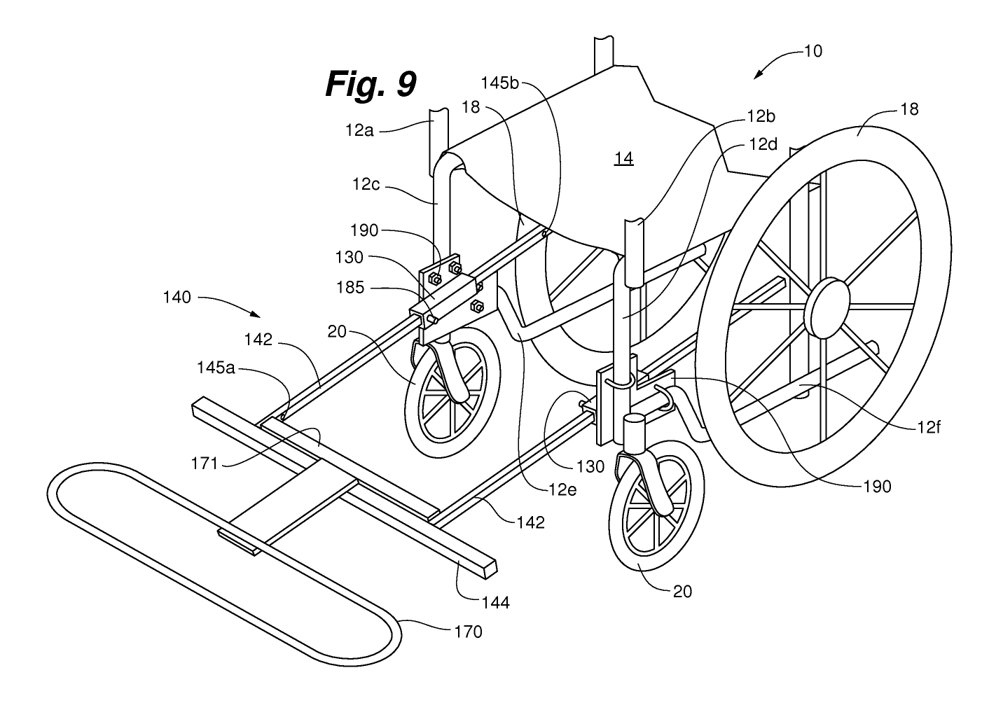

Referring now to FIG. 9 is shown a lower portion of a wheelchair 10, which one of ordinary skill in the art will appreciate may contain the other features of the wheelchair 10 as illustrated in at least FIG. 1. The wheelchair lift attachment 140 may be retrofit such as to be attachable and detachable to the wheelchair 10 by the receiving members 130 being attached to the frame 12 of the wheelchair 10 by a bracket 190 that operably engages the frame 12. In some embodiments, as shown in FIGS. 9 and 15, each of the receiving members 130 are connected to a bracket 190, each of the brackets 190 capable of being attached to at least one of the front frame members 12c, 12d and the respective lower horizontal frame members 12e, 12f by fastening means, such as a U-bolt and screws or the like. In this configuration, when the bracket 190 having the receiving member 130 is operably connected to the respective front frame member 12c and respective lower horizontal frame member 12e (equally applicable to front frame member 12d and lower horizontal frame member 120, the receiving member 130 is capable of receiving the ends of respective arm members 142 connected to lifting or handhold member 144. Preferably, the connecting arm members 142 are fastened into place when inserted into receiving members 130 for operational use. This may be accomplished by receiving members 130 and connecting arm members 142 containing corresponding fastening means, such as apertures 145 for insertion of a fastener 185 such as a pin, bolt, spring-bolt, or the like. The receiving members 130 may also consist of various shapes to accommodate the shape of the one or more connecting arm members 142. In some aspects, the receiving members 130 attached to the frame 12 by the bracket 190 become essentially a part of the frame 12 while still maintaining the ability to be removed.

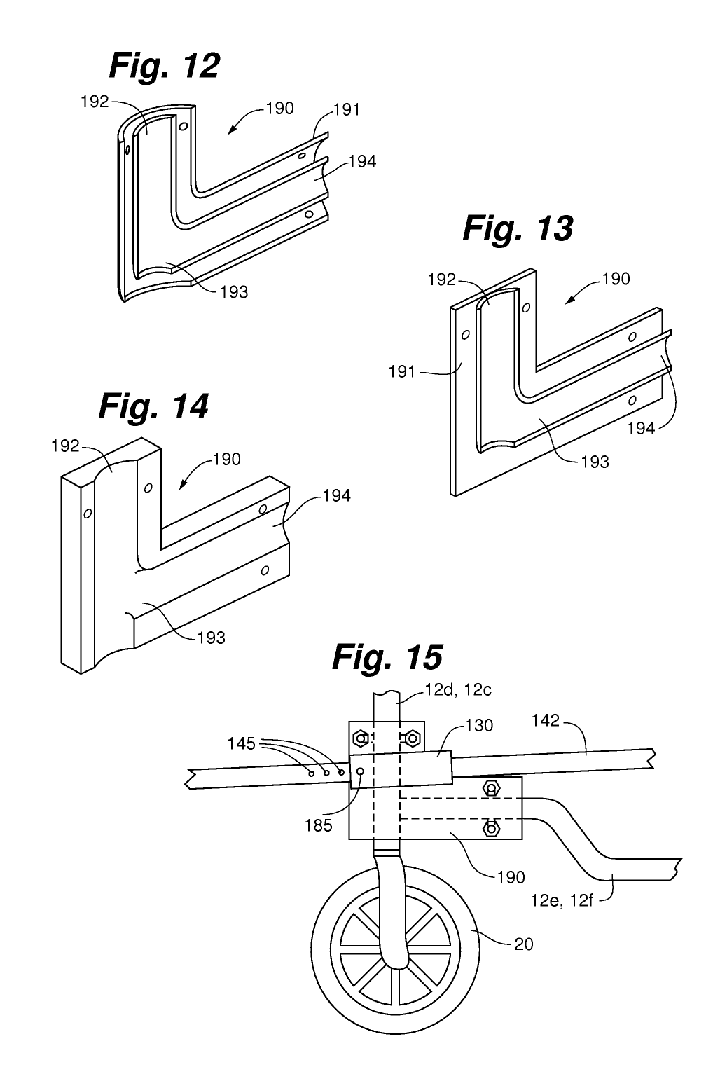

Referring now to FIGS. 9 and 12-14, the bracket 190 is illustrated as having various configurations with the receiving member 130 not shown for ease of reference only. As shown in FIG. 15, each of the bracket 190 configurations, as shown in FIGS. 9 and 12-14, may be retroactively attached to the frame 12 of a wheelchair 10, such as the respective front frame member 12c, 12d and the respective lower frame member 12e, 12f. In some embodiments, such as shown in FIG. 9, the bracket 190 has a flat surface that operable engages the respective frame 12. In some embodiments, such as shown in FIG. 12, the bracket 190 comprises an outer concave portion 191 connected to an inner concave portion 193, the inner concave portion 193 having a first channel 192 for operably engaging the respective front frame member 12c, 12d and a second channel 194 for operably engaging the respective lower frame member 12e, 12f. In some embodiments, such as shown in FIG. 13, the bracket 190 comprises a flat outer portion 191 connected to an inner concave portion 193, the inner concave portion 193 having a first channel 192 for operably engaging the respective front frame member 12c, 12d and a second channel 194 for operably engaging the respective lower frame member 12e, 12f. In some embodiments, such as shown in FIG. 14, the bracket 190 has an inner concave portion 193 integral to the bracket 190, such that the inner concave portion 193 has a first channel 192 for operably engaging the respective front frame member 12c, 12d and a second channel 194 for operably engaging the respective lower frame member 12e, 12f. One of ordinary skill in the art will appreciate that other configurations and variations of the bracket 190 are contemplated without departing from the spirit and scope of the present invention.

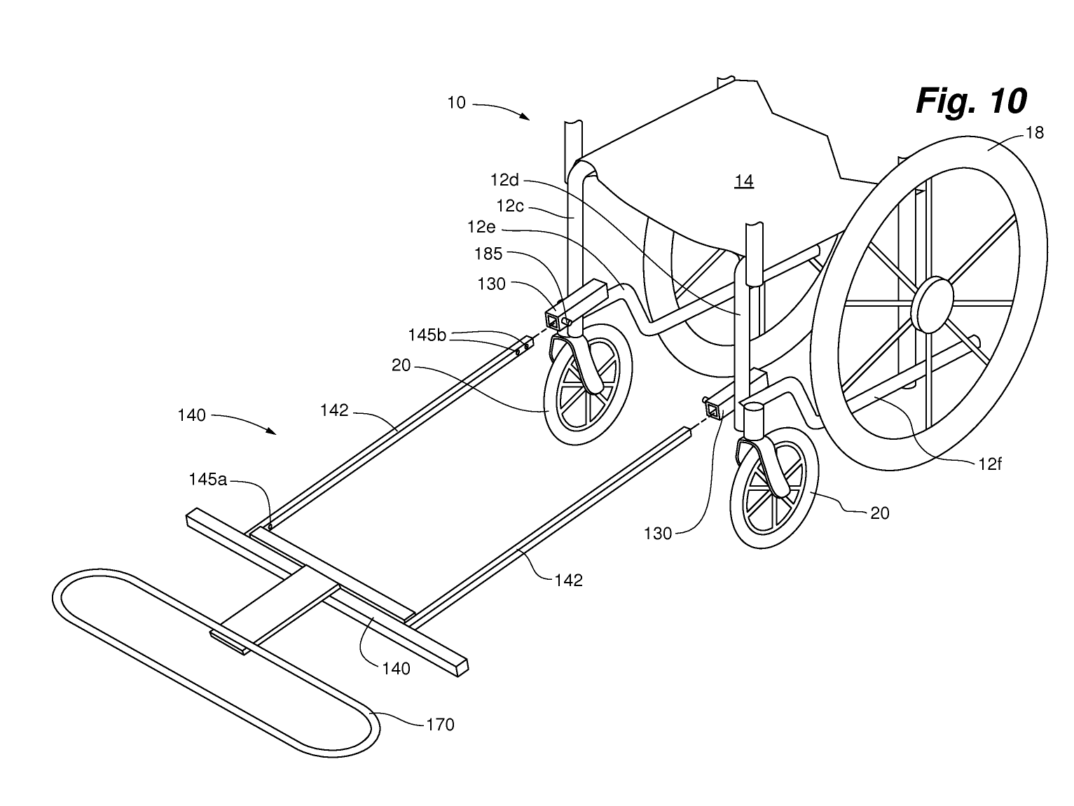

Referring now to FIG. 10, a lower portion of a wheelchair 10 is also shown, which one of ordinary skill in the art will appreciate may contain the other features of the upper portion of the wheelchair 10 as illustrated in at least FIG. 1. The wheelchair lift attachment 140 may be attachable and detachable to the wheelchair 10 by the receiving members 130 being attached to the front portion of the frame 12 of the wheelchair 10. In some embodiments, as shown in FIG. 10, each of the receiving members 130 are integral with the front portion of the frame 12 and located below the seat 14, such as being located proximate the front frame members 12c, 12d and the respective lower horizontal frame members 12e, 12f. In some aspects, the receiving members 130 are integral with the frame 12 and located below the seat 14 proximate the front frame members 12c, 12d, such that the receiving members 130 may be located at any position with respect to the front frame members 12c, 12d below the seat. In some aspects, the receiving members 130 are connected to and located between the front frame members 12c, 12d below the seat. In some aspects, the receiving members 130 are connected to and located outside the front frame members 12c, 12d (not-shown) below the seat. In either of these foregoing configurations, when the receiving member 130 is operably connected to the frame 12 located below a plane defined by the seat 14, the receiving member 130 is capable of receiving the ends of respective arm members 142 connected to lifting or handhold member 144. Preferably, the connecting arm members 142 are fastened into place when inserted into receiving members 130 for operational use. This may be accomplished by receiving members 130 and connecting arm members 142 containing corresponding fastening means, such as apertures 145 for insertion of a fastener 185 such as a pin, bolt, spring-bolt, or the like. The receiving members 130 may also consist of various shapes to accommodate the shape of the one or more connecting arm members 142. In some aspects, the receiving members 130 attached to the frame 12 by the bracket 190 become essentially a part of the frame 12 while still maintaining the ability to be removed.

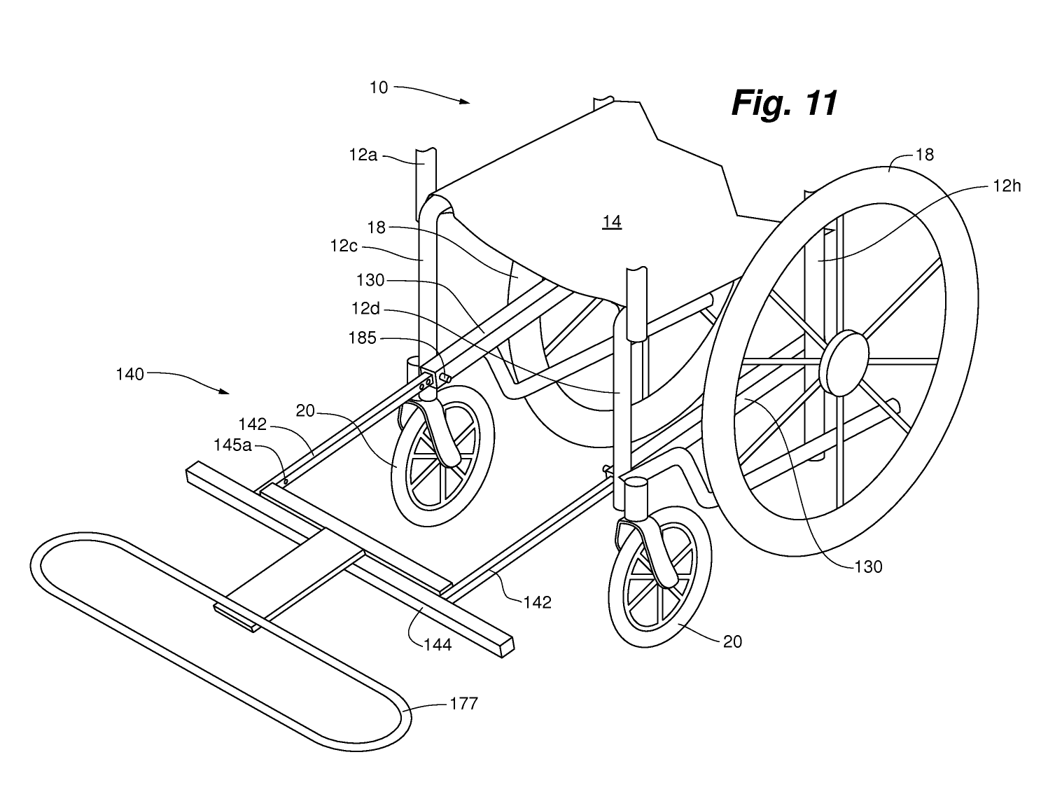

Referring now to FIG. 11, a lower portion of a wheelchair 10 is also shown, which one of ordinary skill in the art will appreciate may contain the other features of the upper portion of the wheelchair 10 as illustrated in at least FIG. 1. The wheelchair lift attachment 140 may be attachable and detachable to the wheelchair 10 by the receiving members 130 being attached to the front portion of the frame 12 of the wheelchair 10 and extending to the back portion of the frame 12. In some embodiments, as shown in FIG. 11, each of the receiving members 130 are integral with the front and back portions of the frame 12 and located below the seat 14, such as being located proximate the front frame members 12c, 12d and spanning to the respective vertical wheel support frame 12g, 12h. In some aspects, the receiving members 130 are integral with the frame 12 and located below the seat 14 proximate the front frame members 12c, 12d and spanning to the respective vertical wheel support frame 12g, 12h, such that the receiving members 130 may be located at any position with respect to at least the front frame members 12c, 12d below the seat. In some aspects, the receiving members 130 are connected to and located between the front frame members 12c, 12d below the seat. In some aspects, the receiving members 130 are connected to and located outside the front frame members 12c, 12d (not-shown) below the seat. In either of these foregoing configurations, when the receiving member 130 is operably connected to the frame 12 located below a plane defined by the seat 14, the receiving member 130 is capable of receiving the ends of respective arm members 142 connected to lifting or handhold member 144. Preferably, the connecting arm members 142 are fastened into place when inserted into receiving members 130 for operational use. This may be accomplished by receiving members 130 and connecting arm members 142 containing corresponding fastening means, such as apertures 145 for insertion of a fastener 185 such as a pin, bolt, spring-bolt, or the like. The receiving members 130 may also consist of various shapes to accommodate the shape of the one or more connecting arm members 142. In some aspects, the receiving members 130 attached to the frame 12 by the bracket 190 become essentially a part of the frame 12 while still maintaining the ability to be removed.

In some aspects, the wheelchair lift attachment 140 may be attachable and detachable to the wheelchair 10 by the receiving members 130 being attached to the front portion of the frame 12 of the wheelchair 10 and extending to the back portion of the frame 12. In some aspects, the receiving members 130 spanning the distance between the front portion and the back portion of the frame 12 may be attached to the frame 12 by one or more brackets 190, such as a front bracket attached to the front portion and a back bracket attached to the back portion of the frame 12.

Referring now to FIGS. 9-11, the connecting arm members 142 may be fully inserted into the receiving members 130 whereby at least a portion of the connecting arm members 142 may slide under the seat 14 of the wheelchair 10 such as to be adjusted to a retracted position. The connecting arm members 142 may adjustably slide from the retracted position to an extended operative position, FIG. 11, or an intermediate position thereto, FIG. 9. In either the retracted position, the extended position, or an intermediate position, the connecting arm members 42 may be locked in place by fastening means, such as a pin, nut and bolt, or the like. For instance, as illustrated in FIGS. 9-11, in the retracted position the fastener 185 may operably interact with the aperture 145a, while in the extended operative position the fastener 185 may operably interact with an aperture 145b. Alternatively, the connecting arm members 142 with the lifting or handhold member 144 may be disconnected from the wheelchair 10 altogether by removing the ends of the connecting arm members 142 from the receiving members 130 of the wheelchair 10 when not in an operational mode. In some aspects, the connecting arm members 142 and lifting member 144 portion of the wheelchair lift attachment apparatus 140 may also have a foot support member 170. Preferably, the foot support member 170 adjusts between an extended position and a retracted position by a hinge-type mechanism 171. Alternatively, the foot support member 170 is in a fixed position relative to the lifting member 144 or the connecting arm members 142. The foot support 170 provides the occupant of the wheelchair with a position to place his/her feet both when the connecting arm members 142 are in the retracted position, extended position, or an intermediate position thereto.

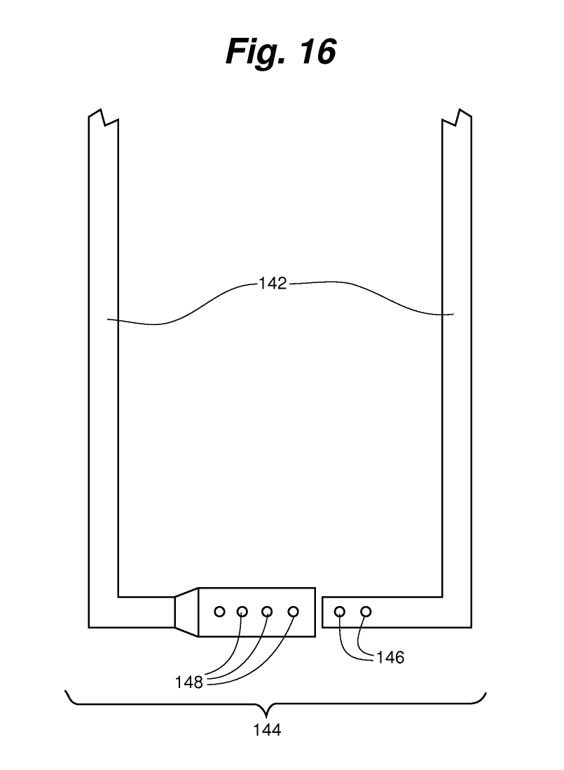

Referring now to FIG. 16, the distance between the connecting arm members 142 may be adjusted to accommodate wheelchairs having different widths between the receiving members 130. In some embodiments, such as shown in FIG. 16, the lifting or handhold member 144 may have means for adjustment for varying the distance between the connecting arm members 142. In some aspects, the lifting or handhold member 144 has one or more fasteners 146 such as a pin, bolt, spring-bolt, or the like for operably engaging and insertion into one or more respective apertures 148.

In a preferred embodiment, the wheelchair lift attachment components and permanent wheelchair components of the present invention are comprised of a robust material, such as steel, aluminum, iron, or any other metal or metal alloy. In a preferred embodiment, the wheelchair lift attachment components and permanent wheelchair components are comprised of the same material as the wheelchair. The wheelchair lift attachment of the present invention may also consist of various shaped materials, such as square-tubular, cylindrical or other shaped materials, and may be solid or hollow. One of ordinary skill in the art will appreciate these variations in the design without departing from the spirit and scope of the present invention.

1. A wheelchair comprising:
a frame having a first front frame member spaced a first distance from a second front frame member;
at least two wheels connected to the frame;
a seat supported by the frame;
a first receiving member located proximate the first front frame member and below a plane defined by the seat, and a second receiving member located proximate the second front frame member and below the plane defined by the seat;
wherein the first and second front frame members extending away from the plane defined by the seat in at least a direction towards the ground; and
wherein the first receiving member is capable of operably engaging a first arm member of a wheelchair lift apparatus and the second receiving member is capable of operably engaging a second arm member of the wheelchair lift apparatus.

2. The wheelchair of claim 1, wherein the first receiving member is attached to a first bracket and the second receiving member is attached to a second bracket, the first bracket operably attachable and detachable to the first front frame member and the second bracket operably attachable and detachable to the second front frame member.

3. The wheelchair of claim 2, the frame further comprising a first lower frame member connected to the first front frame member and a second lower frame member connected to the second front frame member, and the first bracket operably attachable and detachable to the first lower frame member and the second bracket operably attachable and detachable to the second lower frame member.

4. The wheelchair of claim 3, wherein the first bracket has a concave channel for operably engaging at least a portion of the first front frame member and at least a portion of the first lower frame member.

5. The wheelchair of claim 1, wherein the first and second receiving members are located between the first and second front frame members.

6. The wheelchair of claim 1, wherein the first receiving member is attached to the first front frame member, and the second receiving member is attached to the second front frame member.

7. The wheelchair of claim 6, the frame further comprising a first back frame member spaced a second distance from a second back frame member, wherein the first receiving member is attached to the first back frame member, and the second receiving member is attached to the second back frame member.

8. The wheelchair of claim 1, further comprising the wheelchair lift apparatus operably attached to the first and second receiving members, the wheelchair lift apparatus capable of being adjusted between a retracted position and an extended operative position.

9. The wheelchair of claim 8, wherein the wheelchair lift apparatus comprises a hand holding member with a configuration for adjusting the width of the hand holding member.

10. A wheelchair comprising:
a frame having a first front frame member, a second front frame member, a first back frame member, and a second back frame member, the first and second front frame members spaced a first distance and the first and second back frame members spaced a second distance;
a first front wheel connected to the first front frame member and a second front wheel connected to the second front frame member;
a first back wheel connected to the first back frame member and a second back wheel connected to the second back frame member;
a seat supported in a substantially horizontal configuration by the frame; and
a first receiving member connected to the first front frame member and a second receiving member connected to the second front frame member, the first and second receiving members located below a plane defined by the seat and capable of operably engaging a wheelchair lift apparatus.

11. The wheelchair of claim 10, wherein the first and second receiving members are located between the first and second front frame members.

12. The wheelchair of claim 10, wherein the first receiving member is attached to the first front frame member and the first back frame member.

13. The wheelchair of claim 10, wherein the first receiving member is attached to a first bracket and the second receiving member is attached to a second bracket, the first bracket operably attachable and detachable to the first front frame member and the second bracket operably attachable and detachable to the second front frame member.

14. The wheelchair of claim 10, further comprising the wheelchair lift apparatus operably attached to the first and second receiving members.

15. The wheelchair of claim 14, the wheelchair lift apparatus comprising a first connecting arm connected to a second connecting arm by a handhold member located between the first and second connecting arms, the first receiving member operably engaging the first connecting arm and the second receiving member operably engaging the second connecting arm.

16. The wheelchair of claim 15, wherein the wheelchair lift apparatus is capable of being adjusted between a retracted position and an extended operative position.

17. A wheelchair lift apparatus for attachment to a wheelchair, the apparatus comprising:
a first elongate arm with a distal end and a proximal end, a second elongate arm with a distal end and a proximal end, and a handle portion located between and the first and second elongate arms proximate the proximal ends of the first and second elongate arms such that the first and second elongate arms are substantially parallel;
a first receiving member attached to a first bracket; and
a second receiving member attached to a second bracket;
wherein the first bracket is capable of operably attaching to a first frame member of the wheelchair, and the second bracket is capable of operable attaching to a second frame member of the wheelchair; and
wherein the first receiving member operably engages the distal end of the first elongate arm, and the second receiving member operable engages the distal end of the second elongate arm.

18. The wheelchair lift apparatus of claim 17, wherein the first bracket has a concave channel for operably engaging the first frame member.

19. The wheelchair lift apparatus of claim 17, wherein the first elongate arm is adjustably slidable within the first receiving member and the second elongate arm is adjustably slidable within the second receiving member.

20. The wheelchair lift apparatus of claim 19, wherein the first and second elongate arms are capable of being adjusted between a retracted position and an extended operative position.
